(19) United States
(12) Patent Application Publication
(10) Pub. No.: US 2026/0264568 A1
(43) Pub. Date: Sep. 10, 2026

(54) ELEVATION BASED CHARGE LIMITING SYSTEM AND METHOD

(71) Applicant: International Truck Intellectual Property Company, LLC, Lisle, IL (US)

(72) Inventor: Bhupendra Jadhav, Chicago, IL (US)

(73) Assignee: International Truck Intellectual Property Company, LLC, Lisle, IL (US)

(21) Appl. No.: 19/073,680

(22) Filed: Mar. 7, 2025

(51) Int. Cl. B60L 58/15; B60L 7/10

(52) U.S. Cl. CPC B60L 58/15; B60L 7/10; B60L 2240/26; B60L 2240/66

(57) ABSTRACT

An elevation based charge limiting system is provided for adjusting a charge limit of a battery in a vehicle based on determined elevation information. The elevation based charge limiting system may include a battery, electric drive components, motor, charge controller, power electronics, charge adjustment component, analytic component and sensors. A method for adjusting a charge limit of a battery in a vehicle based on determined elevation information using the elevation based charge limiting system is also provided.

### FIELD OF THE INVENTION

The present disclosure relates to an elevation based charge limiting system. More particularly, the disclosure relates to adjusting a charge limit of a battery in a vehicle based on determined elevation information.

### BACKGROUND

Battery Electric Vehicles (BEVs) and potentially hybrid vehicles face unique challenges in managing battery state of charge (SOC) at high elevations. When a BEV's battery is near or at full capacity (100% SOC) and the vehicle begins to descend a steep incline, regenerative braking can push the SOC beyond the maximum limit of a battery. This overcharging scenario can lead to thermal events or even damage the battery, creating a significant safety concern.

To mitigate this risk, regenerative braking is often disabled when the battery reaches a high SOC. However, this places an increased burden on the foundation brakes and associated brake pads to slow the vehicle down during downhill driving. Excessive reliance on the foundation brakes can lead to overheating, premature wear, and potentially even brake failure, compromising the vehicle's overall safety.

Therefore, a need exists to solve the deficiencies present in the prior art. What is needed is a system to reduce the risk of overcharge of a battery in a vehicle due to excessive regenerative braking due to decreases in elevation. What is needed is a system to increase operational safety and durability of batteries in vehicles with electric drive components attributed to elevation changes. What is needed is a system and method to decrease wear on foundation brakes by providing a buffer capacity in batteries of vehicles with at least partially electric powertrains to permit regenerative braking.

### SUMMARY

An aspect of the disclosure advantageously provides a system to reduce the risk of overcharge of a battery in a vehicle due to excessive regenerative braking due to decreases in elevation. An aspect of the disclosure advantageously provides a system to increase operational safety and durability of batteries in vehicles with electric drive components attributed to elevation changes. An aspect of the disclosure advantageously provides a system and method to decrease wear on foundation brakes by providing a buffer capacity in batteries of vehicles with at least partially electric powertrains to permit regenerative braking.

Accordingly, the disclosure featuring a battery state of charge limiting and control system is provided including a charge controller with an analytic component, a charge adjustment component, and power electronics. The charge controller may manage charging characteristics of a battery having a maximum storage capacity. The charging characteristics may include a charge limit set to the maximum storage capacity by default. The charge controller may include an analytic component to interpret information comprising barometric pressure that is received by a sensor to calculate a determined elevation to determine an adjusted storage capacity for the battery respective of the determined elevation. The charge controller may also include a charge adjustment component to selectively adjust the charge limit to the adjusted storage capacity. Additionally, the charge controller may include power electronics to affect the charging characteristics for the battery such that charging the battery from a power source does not exceed the charge limit. The adjusted storage capacity may be determined by the analytic component to provide a buffer charge capacity that is sufficient to substantially mitigate a risk of overcharge caused by regenerative braking raising an instant state of charge of the battery to exceed its maximum storage capacity. The adjusted storage capacity may be reduced to correspond with the determined elevation being increased.

In another aspect, the information further comprises a load weight, and the sensor may include a load sensor to detect the load weight.

In another aspect, the adjusted storage capacity may be reduced to correspond with the load weight being increased.

In another aspect, the information may include the barometric pressure, load weight, the instant state of charge, battery capacity, travel distance since the battery was last charged, and an initial trip state of charge.

According to an embodiment of this disclosure, a battery state of charge limiting and control system is provided including a charge controller having an analytic component, a charge adjustment component, and power electronics. The charge controller may manage charging characteristics of a battery having a maximum storage capacity, the charging characteristics including a charge limit set to the maximum storage capacity by default. The charge controller may include an analytic component to interpret information comprising environmental conditions indicative of a determined elevation that is received by a sensor to determine an adjusted storage capacity for the battery respective of the environmental condition. The charge controller may also include a charge adjustment component to selectively adjust the charge limit to the adjusted storage capacity. Additionally, the charge controller may include power electronics to affect the charging characteristics for the battery such that charging the battery from a power source does not exceed the charge limit. The adjusted storage capacity may be determined by the analytic component to provide a buffer charge capacity that is sufficient to substantially mitigate a risk of overcharge caused by regenerative braking raising an instant state of charge of the battery to exceed its maximum storage capacity.

In another aspect, the information includes barometric pressure.

In another aspect, the barometric pressure is interpreted by the analytic component to calculate the determined elevation. The adjusted storage capacity may be reduced to correspond with the determined elevation being increased.

In another aspect, the information further includes a load weight. The sensor may include a load sensor to detect the load weight.

In another aspect, the adjusted storage capacity is reduced to correspond with the load weight being increased.

In another aspect, the information includes barometric pressure, load weight, the instant state of charge, battery capacity, travel distance since the battery was last charged, and an initial trip state of charge.

According to an embodiment of this disclosure, a method is provided for limiting and controlling a battery state of charge respective to a determined elevation. The method includes the step (a) determining information comprising environmental conditions received from a sensor. The method additionally includes (b) managing charging characteristics of a battery having a maximum storage capacity via a charge controller, the charging characteristics comprising a charge limit set to the maximum storage capacity by default. Step (b) further includes (i) interpreting the information via an analytic component, the information being indicative of the determined elevation, (ii) determining an adjusted storage capacity for the battery respective of the environmental condition, and (iii) selectively adjusting the charge limit to the adjusted storage capacity via a charge adjustment component. The method additionally includes (c) affecting the charging characteristics for the battery via power electronics such that charging the battery from a power source does not exceed the charge limit. Furthermore, the method includes (d) substantially mitigating a risk of overcharge caused by regenerative braking raising an instant state of charge of the battery to exceed its maximum storage capacity by determining the adjusted storage capacity to provide a buffer charge capacity.

In another aspect of the method, the information includes barometric pressure. In this aspect, the method further includes (e) interpreting the barometric pressure by the analytic component to calculate the determined elevation.

In another aspect of the method, the steps include (f) reducing the adjusted storage capacity to correspond with an increase in the determined elevation.

In another aspect of the method, the information further includes a load weight, and the sensor comprises a load sensor to detect the load weight. In this aspect, the method further includes (g) reducing the adjusted storage capacity to correspond with the load weight being increased.

In another aspect of the method, the information includes barometric pressure, load weight, the instant state of charge, battery capacity, travel distance since the battery was last charged, and an initial trip state of charge.

Terms and expressions used throughout this disclosure are to be interpreted broadly. Terms are intended to be understood respective to the definitions provided by this specification. Technical dictionaries and common meanings understood within the applicable art are intended to supplement these definitions. In instances where no suitable definition can be determined from the specification or technical dictionaries, such terms should be understood according to their plain and common meaning. However, any definitions provided by the specification will govern above all other sources.

Various objects, features, aspects, and advantages described by this disclosure will become more apparent from the following detailed description, along with the accompanying drawings in which like numerals represent like components.

### BRIEF DESCRIPTION OF THE DRAWINGS

FIG. 1 is a block diagram view of an illustrative battery state of charge limiting and control system, according to an embodiment of this disclosure.

FIG. 2 is a graph view of an illustrative charge limit relative to determined elevation, according to an embodiment of this disclosure.

FIG. 3 is a graph view of an illustrative instant state of charge relative to distance traveled over varying elevation and load parameters, according to an embodiment of this disclosure.

FIG. 4 is a flowchart view of an illustrative operation of calculating a determined elevation and adjusting a charge limit of a battery with respect to same, according to an embodiment of this disclosure.

### DETAILED DESCRIPTION

The following disclosure is provided to describe various embodiments of an elevation based charge limiting system. Skilled artisans will appreciate additional embodiments and uses of the present invention that extend beyond the examples of this disclosure. Terms included by any claim are to be interpreted as defined within this disclosure. Singular forms should be read to contemplate and disclose plural alternatives. Similarly, plural forms should be read to contemplate and disclose singular alternatives. Conjunctions should be read as inclusive except where stated otherwise.

Expressions such as “at least one of A, B, and C” should be read to permit any of A, B, or C singularly or in combination with the remaining elements. Additionally, such groups may include multiple instances of one or more element in that group, which may be included with other elements of the group. All numbers, measurements, and values are given as approximations unless expressly stated otherwise.

For the purpose of clearly describing the components and features discussed throughout this disclosure, some frequently used terms will now be defined, without limitation. The term charge controller, as it is used throughout this disclosure, is defined as a device that manages the flow of electricity to and from the battery, ensuring optimal charging, preventing overcharging, and maximizing battery lifespan and performance. The term battery, as it is used throughout this disclosure, is defined as a rechargeable energy storage device that powers the motor and other electrical components, providing the vehicle with its driving range. The term determined elevation, as it is used throughout this disclosure, is defined as an estimated altitude above sea level based on the relationship between atmospheric pressure and altitude.

The term power source, as it is used throughout this disclosure, is defined as an external supply of electricity used to replenish the energy stored in the vehicle's battery. The term overcharge, as it is used throughout this disclosure, is defined as the condition where the battery is charged beyond its maximum recommended state of charge, which can lead to damage or reduced lifespan. The term regenerative braking, as it is used throughout this disclosure, is defined as a process that captures the kinetic energy generated during deceleration and converts it into electrical energy, which is then used to recharge the battery. The term barometric pressure, as it is used throughout this disclosure, is defined as the force exerted by the weight of the atmosphere above a given point. The term load weight, as it is used throughout this disclosure, is defined as the total weight of the passengers, cargo, and any other items being transported by the vehicle.

Various aspects of the present disclosure will now be described in detail, without limitation. In the following disclosure, an elevation based charge limiting system will be discussed. Those of skill in the art will appreciate alternative labeling of the elevation based charge limiting system as an elevation-based battery storage adjustment system, battery management system for mitigating overcharge due to elevation changes, battery management system, the invention, or other similar names. Similarly, those of skill in the art will appreciate alternative labeling of the elevation based charge limiting system as a method of managing a battery charging system operated with changes in elevation, environment sensing battery management operation, method of contextually managing battery operations, method, operation, the invention, or other similar names. Skilled readers should not view the inclusion of any alternative labels as limiting in any way.

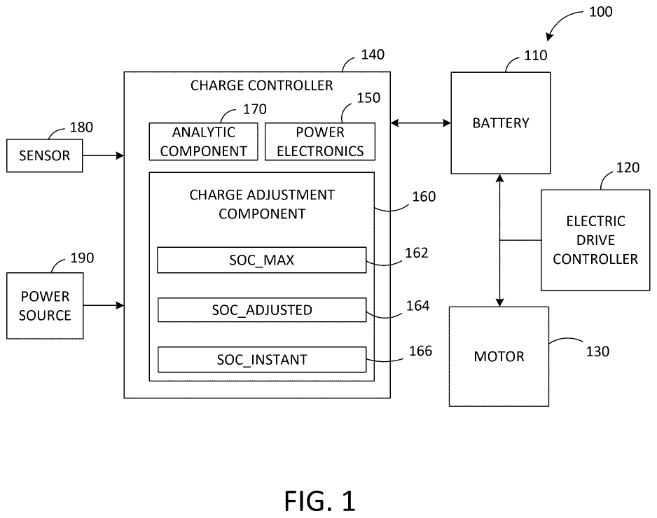

Referring now to FIGS. 1-4, the elevation based charge limiting system will now be discussed in more detail. The elevation based charge limiting system may include a battery, electric drive components, motor, charge controller, power electronics, charge adjustment component, analytic component, sensors, and additional components that will be discussed in greater detail below. The elevation based charge limiting system may operate one or more of these components interactively with other components for adjusting a charge limit of a battery in a vehicle based on determined elevation information. In some embodiments, a user will be provided an option as whether to enable a system enabled by this disclosure to adjust the charge limits of a battery.

The battery will now be discussed in greater detail. Block diagram 100 of FIG. 1 highlights examples of the battery, which may also be shown in other figures. A battery serves as an energy source for electric vehicles, hybrid electric vehicles, and other vehicles including powertrains with at least partial electric drive assistance. Electric powertrains, such as being powered from a battery 110, advantageously provide considerable torque to drive the vehicle, reduce fuel consumption, and encourage clean and sustainable operation by reducing harmful tailpipe emissions and reducing greenhouse gas emissions. Additionally, batteries enable electric vehicles to operate more quietly, reducing noise in urban environments or other areas that may include operational noise restrictions.

Moreover, batteries can offer a more efficient and cost-effective way to power vehicles. Electric motors are inherently more efficient than internal combustion engines, converting a higher percentage of stored energy into motion. This translates to lower operating costs for electric vehicle owners, as electricity is typically cheaper than gasoline. Furthermore, batteries allow for regenerative braking, a process that captures energy during deceleration and stores it back in the battery 110, increasing overall energy efficiency and extending the vehicle's range.

In one embodiment, the batteries used with a system enabled by this disclosure may be lithium-ion batteries, which offer a high energy density in a lightweight package. Lithium-ion batteries (Li-ion) also have a long lifespan and can withstand many charges and discharge cycles. However, those of skill in the art will appreciate alternative battery chemistries and/or structures that may be used with a system enabled by this disclosure including, without limitation, nickel-metal hydride (NiMH), lead-acid, solid-state, capacitors and ultracapacitors, lithium-sulfur, lithium-air, metal-air, and/or other structures.

In an embodiment using lithium-ion batteries, power is stored and released through the movement of lithium ions between two electrodes: the anode (negative) and cathode (positive). During discharge, lithium ions flow from the anode through an electrolyte to the cathode, creating an electrical current that powers the vehicle. When charging, the process is reversed, with lithium ions moving back to the anode. This cycle of charging and discharging is what makes the battery 110 rechargeable.

The electric drive components will now be discussed in greater detail. Block diagram 100 of FIG. 1 highlights examples of the electric drive components, which may also be shown in other figures. In an electric vehicle, the battery 110 may store an electrical charge in the form of chemical potential energy. When the driver presses the accelerator, an electric drive controller 120 may cause the stored energy to be released as an electrical current that flows to the electric motor 130. The motor 130 may then convert this electrical energy into mechanical energy, creating the torque that turns the wheels and propels the vehicle forward.

The electric drive controller 120 may control the flow of electrical energy between the battery 110 and the motor 130. The electric drive controller 120 may receive an input from the accelerator pedal and other sensors, interpreting the driver's intended actions to regulate the amount of current drawn from the battery 110 and delivered to the motor 130. The acceleration, speed, and torque may be affected by the current delivered to the motor 130 from the battery 110.

The electric drive controller 120 may additionally manage regenerative braking. For example, when the driver lifts their foot off the accelerator and/or applies the brakes, the electric drive controller 120 may reverse the flow of electrical current. In this example, instead of the battery 110 powering the motor 130, the motor 130 acts as a generator to convert at least part of the kinetic energy of the vehicle into electrical energy, which may be provided to the battery 110 to at least partially increase the instant state of charge of the battery 110.

The efficiency and effectiveness of the electric drive controller 120 affect the vehicle's range and performance. By controlling the current flow and optimizing regenerative braking, the controller can reduce energy losses and increase the amount of energy recovered during deceleration. This not only extends the driving range of the electric vehicle but also reduces wear and tear on the traditional braking system.

Moreover, the electric drive controller 120 is responsible for ensuring the safety and reliability of the powertrain. It continuously monitors various parameters such as voltage, current, and temperature, implementing protective measures to prevent overcharging, overheating, or other potential hazards. In some embodiments, the electric drive controller 120 may also communicate with other vehicle systems, such as the battery management system and the thermal management system, to ensure optimal operating conditions for all components.

The motor will now be discussed in greater detail. Block diagram 100 of FIG. 1 highlights examples of the motor, which may also be shown in other figures. Electric motors used in vehicles convert electrical energy from the battery 110 into mechanical energy that drives the wheels. These motors are typically smaller, lighter, and more efficient than traditional internal combustion engines, advantageously offering instant torque and smooth power delivery. Moreover, electric motors also typically have fewer moving parts than combustion engines, advantageously resulting in lower maintenance requirements and longer lifespans.

In one embodiment, a motor 130 operable with a system enabled by this disclosure may be a permanent magnet synchronous motor (PMSM), however those of skill in the art will appreciate other types of motors that may be used such as induction motors and switched reluctance motors, without limitation. A motor 130 operable with a system enabled by this disclosure may additionally operate in reverse as generators. Electric generation from a motor 130 is utilized in regenerative braking, a process where the motor 130 converts kinetic energy of a vehicle into electrical energy during deceleration. Instead of dissipating this energy as heat through traditional friction brakes, regenerative braking captures it and stores it back in the battery 110. Regenerative braking advantageously improves vehicle efficiency, extends driving range, and reduces fuel consumption.

The amount of energy recovered through regenerative braking depends on various factors, including the vehicle's speed, the intensity of braking, and the efficiency of the motor 130 and control system. In some cases, regenerative braking can recover a significant portion of the energy used during acceleration, making it a valuable feature for maximizing the range of electric vehicles.

However, overcharging a lithium-ion or other battery may occur when the charging process continues beyond the battery's maximum capacity, such as from excessive regenerative braking. This can lead to several risks, including lithium plating where excess lithium ions can deposit on the anode, heat that can lead to a chain reaction that can result in fire or explosion, reduced lifespan, and other undesirable consequences. The state of charge of a battery 110 can be affected using a charge controller 140 enabled by this invention, as discussed below.

The charge controller will now be discussed in greater detail. Block diagram 100 of FIG. 1 highlights examples of the charge controller, which may also be shown in other figures. According to an embodiment of this disclosure, a charge controller 140 may be used to manage charging characteristics of a battery 110 having a maximum storage capacity. The charging characteristics may include a charge limit to affect the amount of electrical charge that may be stored in a battery 110 such to mitigate the risk of overcharge. The charge limit may be set to the maximum storage capacity by default, with the charge controller 140 being able to affect the charge limit to a value that is less than the maximum storage capacity of the battery 110 in response to environmental conditions such as determined altitude, without limitation.

In one embodiment, the charge controller 140 may affect a charge limit of the battery 110 in response to detected environmental conditions. The charge controller 140 may regulate the charging process and reduce the risk of overcharging, which can damage the battery 110 and even pose safety hazards. The charge controller 140 may include power electronics 150 and charging circuitry, charge adjustment component 160 to affect the charge limit for the battery 110, and analytic component 170 to assess information provided by sensors 180 and determine an environmental condition such as altitude. The information may be provided by sensors 180, for example, a barometric pressure sensor. This barometric pressure sensor measures the atmospheric pressure, which decreases with increasing altitude. By analyzing the barometric pressure data, the analytic component 170 can estimate the determined altitude.

The power electronics 150 may manipulate the electrical current used to charge a battery 110, for example, adjusting its voltage and amperage to match the battery 110 charging requirements and/or charge limit. The power electronics 150 may manage the charging process to limit the charging level of the battery 110 to be maintained within safe limits, which may be limited in response to environmental conditions. In one embodiment, the power electronics may include MOSFETs and IGBTs that act as switches, the switching frequency and duty cycle of which may be manipulated to regulate the charging process.

The charge controller 140 may manage the level of charge that the battery 110 receives from a power source 190 depending on the environmental condition. Example of power sources 190 may include a mains power source, charging terminal, charging station, or other device that may be used to charge an electric vehicle that would be appreciated by a person of skill in the art after having the benefit of this disclosure. The charge controller 140 may include a charge adjustment component 160, which may intelligently control the charge levels for the battery 110 based on the environmental condition. The charge adjustment component 160 may selectively adjust the charge limit to the adjusted storage capacity, which may be determined by an analytic component 170 of the charge controller 140 to provide a buffer charge capacity that is sufficient to substantially mitigate a risk of overcharge caused by regenerative braking raising an instant state of charge of the battery 110 to exceed its maximum storage capacity.

The charge adjustment component 160 includes information about the battery 110 and parameters relating to its state of charge (SOC). For example the charge adjustment component 160 may include values for various SOC parameters, including without limitation, a SOC_MAX level 162 indicating the maximum charge capacity of a battery 110, SOC_ADJUSTED level 164 indicating the adjusted charge limit for the battery 110 given the environmental conditions, SOC_INSTANT level 166 indicating the current SOC for the battery 110, and/or other values that would be appreciated by a person of skill in the art after having the benefit of this disclosure, without limitation. Additional values may include a SOC_BUFFER value, which may be indicative of the reserved capacity for the battery 110 to mitigate risk of overcharge that could result in operation with respect to the environmental condition.

The parameters set by the charge adjustment component 160 may be set in relation to the information received and analyzed by the analytic component 170. In one embodiment, an analytic component 170 is included by the charge controller 140 to interpret information comprising environmental conditions indicative of a determined elevation that is received by a sensor 180 to determine an adjusted storage capacity for the battery 110 respective of the environmental condition. The determined elevation may be calculated based on information including barometric pressure detected by a sensor 180.

In one embodiment, the determined elevation may be used to set the SOC_ADJUSTED level 164 to provide a buffer capacity for electrical charge added to the battery 110, such as via regenerative braking from operating a vehicle along a route with a significant elevation decrease, that may surpass the level to which the battery 110 is charged without also exceeding the SOC_MAX level 162.

Including a buffer capacity advantageously provides a safety margin in which additional energy can be stored beyond the adjusted storage capacity. For example, the buffer capacity allows the battery 110 to accept additional charge from regenerative braking without exceeding its absolute maximum capacity, which particularly advantageous during downhill driving or sudden deceleration, where regenerative braking can generate significant amounts of energy. By maintaining a buffer capacity, the charge controller 140 may improve the likelihood that the battery 110 can absorb this energy without risking overcharge, which could lead to damage or even thermal runaway.

In some embodiments, the information may additionally include load weight, and the sensors 180 may include a load sensor to detect the load weight. The adjusted storage capacity may be reduced to correspond with an increase in load weight and thus additional regenerative braking that would be needed along a route with a significant decrease in elevation.

In one example, the amount of energy generated through regenerative braking can vary significantly depending on driving conditions, including speed, terrain, and load weight. A heavier vehicle, for example a truck carrying a full load of cargo, will generate more kinetic energy during braking, potentially exceeding the battery's storage capacity if not managed properly. To account for this variability, the charge controller 140 may additionally consider the load weight of the vehicle when determining the adjusted storage capacity. By factoring in the additional mass, the charge controller 140 can alter the adjusted charge level to increase the buffer capacity accordingly, ensuring that sufficient room remains to accommodate the anticipated increased energy generated by regenerative braking.

By incorporating altitude estimation into its decision-making process, the charge controller 140 can implement adaptive charging strategies. For example, at higher altitudes and/or carrying increased load weights, the charge controller 140 may reduce the charge limit to avoid overstressing the battery 110 such as during regenerative braking. Conversely, at lower altitudes, it may increase the charge limit to improve the battery capacity utilization. These adaptive strategies can significantly enhance charging parameters, improving battery safety, efficiency, and lifespan.

The sensors will now be discussed in greater detail. Block diagram 100 of FIG. 1 highlights examples of the sensors, which may also be shown in other figures. Modern vehicles include a plethora of sensors, which may provide information about operation and environmental conditions relating to a vehicle. Information detected by sensors 180 may include, without limitation, barometric pressure, load weight, the instant state of charge, battery capacity, travel distance since the battery 110 was last charged, and an initial trip state of charge.

Sensors 180 may include a barometric pressure sensor to detect atmospheric pressure data. This information is provided by the sensor 180 to the charge controller 140 to determine if an adjustment to the SOC_ADJUSTED level 164 is appropriate and if so, to what degree, and also may be utilized by the vehicle's control systems for optimizing engine performance based on altitude and other features.

In some embodiments, the sensors 180 may include a load sensor to determine the load weight of a vehicle. In one example, the load sensors, often in the form of load cells, may operate via a strain gauge such that when a load is applied to the vehicle, the chassis or suspension components experience slight deformation. Load cells, strategically placed within these components, detect this deformation, and convert it into information as an electrical signal proportional to the applied load. This information may be then processed by the charge controller 140, which interprets the data and calculates the load weight of the vehicle. The charge controller 140 may analyze the load weight in association with the determined altitude and/or other information to determine an adjusted charge level.

In operation, a method may be provided for adjusting a charge limit of a battery in a vehicle based on determined elevation information. Those of skill in the art will appreciate that the following methods are provided to illustrate an embodiment of the disclosure and should not be viewed as limiting the disclosure to only those methods or aspects. Skilled artisans will appreciate additional methods within the scope and spirit of the disclosure for performing the operations provided by the examples below after having the benefit of this disclosure. Such additional methods are intended to be included by this disclosure.

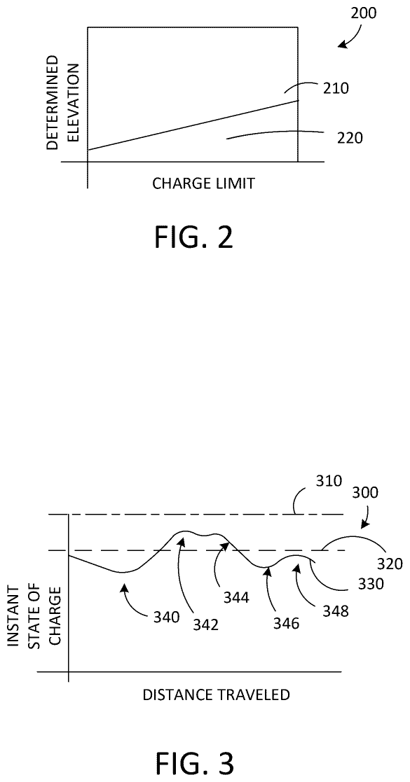

Referring now to FIG. 2, an illustrative graph 200 is provided to visualize an example relationship between determined elevation and charge levels. In graph 200, the adjusted storage capacity is represented by the area indicated by ordinal 210, with the buffer charge capacity being represented by the area indicated by ordinal 220. The sum of the adjusted storage capacity 210 and buffer storage capacity 220 is approximately the maximum storage capacity provided by the battery. As the determined elevation value increases, the adjusted storage capacity 210 is decreased, thus increasing the buffer storage capacity 220.

Referring now to FIG. 3, an illustrative graph 300 is provided to illustrate operating a vehicle with a system enabled by this disclosure. In graph 300, the maximum storage capacity of the battery is represented by line 310. At the relative elevation in this example, the battery was allowed to be charged such that the instant SOC 330 is aligned with the adjusted storage capacity represented by line 320. In this example, as the vehicle begins to operate along a route, the electric charge is consumed from the battery as it travels along an approximately even level of terrain. At event 340, the vehicle may begin to travel along a route with a significant decrease in elevation, which may cause regenerative braking to supply electrical charge to the battery. At event 342, a downhill section may even out to level terrain after storing a significant amount of charge in the battery. As noted by graph 300, the instant SOC 330 at event 342 exceeds the adjusted storage capacity 320 but remains below the maximum storage capacity 310 of the battery.

The vehicle may continue along a route with varying elevations until reaching event 344, all of which may maintain the instant SOC 330 of the battery remains above the adjusted storage capacity 320 and below the maximum storage capacity 310. The vehicle may then continue along the route in a prolonged level and/or uphill section, causing charge to be drawn from the battery until reaching event 346. An additional downhill section may begin at event 346, but while adding charge to the battery, the instant SOC 330 does not exceed the adjusted storage capacity 320. Operation may continue from event 348 as being consistent with this example.

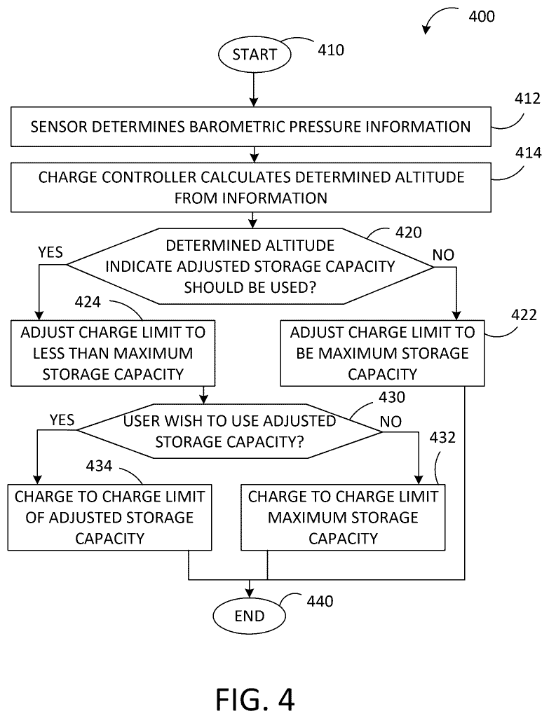

Referring now to flowchart 400 of FIG. 4, an example method for an illustrative operation of calculating a determined elevation and adjusting a charge limit of a battery with respect to same will be described, without limitation. Starting with Block 410, the operation may begin by the sensor determining information about an environmental condition, for example, barometric pressure (Block 412). The charge controller may use the information, for example barometric pressure, to calculate a determined altitude (Block 414).

It may then be decided at Block 420 whether the determined altitude indicates the storage capacity of the battery should be adjusted. If it is decided at Block 420 that an adjusted storage capacity should not be used, the value for the charge limit may be set to the maximum storage capacity of the battery (Block 422). If it is decided at Block 420 that an adjusted storage capacity should be set, then the charge limit may be determined at an adjusted storage capacity that is lower than the maximum storage capacity (Block 424).

In an embodiment where the operation may be manually enabled by a user, a decision may be presented to the user at Block 430 whether to use the adjusted storage capacity as a limit for charging the battery. If it is decided at Block 430 not to use the adjusted storage capacity, the battery may be charged to the maximum storage capacity (Block 432). If it is decided at Block 430 that the adjusted storage capacity should be used, the battery may be charged to the adjusted storage capacity (Block 434). At Block 440, the operation may terminate after Blocks 422, 432, or 434.

In another example, the operation may include a method of limiting and controlling a battery state of charge respective to a determined elevation. In this embodiment, the operation may begin by determining information comprising environmental conditions received from a sensor. Information may include barometric pressure, load weight, and other information that would be apparent to a person of skill in the art after having the benefit of this disclosure. Sensors may include barometric pressure sensors, load sensors, and/or other sensors without limitation.

The operation may then proceed by managing charging characteristics of a battery having a maximum storage capacity via a charge controller. The charging characteristics may include a charge limit, which may be set to the maximum storage capacity of the battery by default. The operation may then analyze the information via an analytic component of the charge controller. The information, being indicative of the determined elevation, may be calculated based on the barometric pressure information. The operation may then determine an adjusted storage capacity for the battery respective of the environmental condition, for example, determined altitude and/or load weight. The charge limit may be selectively adjusted to the adjusted storage capacity via a charge adjustment component of the charge controller.

The operation may then use the power electronics of the charge controller to affect the behavior of charging the battery from a power source so that it does not exceed the charge limit. The operation may then substantially mitigate a risk of overcharge caused by regenerative braking causing an instant state of charge to rise such to exceed its maximum storage capacity by determining the adjusted storage capacity to provide a buffer charge capacity.

In one example, the information comprises barometric pressure and the operation includes interpreting the barometric pressure by the analytic component to calculate the determined elevation. The speed adjusted storage capacity may be reduced to correspond with an increase in the determined elevation. In another example, the information also includes a load weight, and the sensor comprises a load sensor to detect the load weight and reduce the adjusted storage capacity to correspond with the load weight being increased.

While various aspects have been described in the above disclosure, the description of this disclosure is intended to illustrate and not limit the scope of the invention. The invention is defined by the scope of the appended claims and not the illustrations and examples provided in the above disclosure. Skilled artisans will appreciate additional aspects of the invention, which may be realized in alternative embodiments, after having the benefit of the above disclosure. Other aspects, advantages, embodiments, and modifications are within the scope of the following claims.

What is claimed is:

1. A battery state of charge limiting and control system comprising:
a charge controller to manage charging characteristics of a battery having a maximum storage capacity, the charging characteristics comprising a charge limit set to the maximum storage capacity by default, the charge controller comprising:
an analytic component to interpret information comprising barometric pressure that is received by a sensor to calculate a determined elevation to determine an adjusted storage capacity for the battery respective of the determined elevation;
a charge adjustment component to selectively adjust the charge limit to the adjusted storage capacity; and
power electronics to affect the charging characteristics for the battery such that charging the battery from a power source does not exceed the charge limit;
wherein the adjusted storage capacity is determined by the analytic component to provide a buffer charge capacity that is sufficient to substantially mitigate a risk of overcharge caused by regenerative braking raising an instant state of charge of the battery to exceed its maximum storage capacity; and
wherein the adjusted storage capacity is reduced to correspond with the determined elevation being increased.

2. The system of claim 1:
wherein the information further comprises a load weight;
wherein the sensor comprises a load sensor to detect the load weight.

3. The system of claim 2, wherein the adjusted storage capacity is reduced to correspond with the load weight being increased.

4. The system of claim 1, wherein the information comprises the barometric pressure, load weight, the instant state of charge, battery capacity, travel distance since the battery was last charged, and an initial trip state of charge.

5. A battery state of charge limiting and control system comprising:
a charge controller to manage charging characteristics of a battery having a maximum storage capacity, the charging characteristics comprising a charge limit set to the maximum storage capacity by default, the charge controller comprising:
an analytic component to interpret information comprising environmental conditions indicative of a determined elevation that is received by a sensor to determine an adjusted storage capacity for the battery respective of the environmental condition;
a charge adjustment component to selectively adjust the charge limit to the adjusted storage capacity; and
power electronics to affect the charging characteristics for the battery such that charging the battery from a power source does not exceed the charge limit;
wherein the adjusted storage capacity is determined by the analytic component to provide a buffer charge capacity that is sufficient to substantially mitigate a risk of overcharge caused by regenerative braking raising an instant state of charge of the battery to exceed its maximum storage capacity.

6. The system of claim 5, wherein the information comprises barometric pressure.

7. The system of claim 6:
wherein the barometric pressure is interpreted by the analytic component to calculate the determined elevation; and
wherein the adjusted storage capacity is reduced to correspond with the determined elevation being increased.

8. The system of claim 5:
wherein the information further comprises a load weight; and
wherein the sensor comprises a load sensor to detect the load weight.

9. The system of claim 8, wherein the adjusted storage capacity is reduced to correspond with the load weight being increased.

10. The system of claim 5, wherein the information comprises barometric pressure, load weight, the instant state of charge, battery capacity, travel distance since the battery was last charged, and an initial trip state of charge.

11. A method of limiting and controlling a battery state of charge respective to a determined elevation comprising:
(a) determining information comprising environmental conditions received from a sensor;
(b) managing charging characteristics of a battery having a maximum storage capacity via a charge controller, the charging characteristics comprising a charge limit set to the maximum storage capacity by default, further comprising:
(i) interpreting the information via an analytic component, the information being indicative of the determined elevation,
(ii) determining an adjusted storage capacity for the battery respective of the environmental condition, and
(iii) selectively adjusting the charge limit to the adjusted storage capacity via a charge adjustment component; and
(c) affecting the charging characteristics for the battery via power electronics such that charging the battery from a power source does not exceed the charge limit; and
(d) substantially mitigating a risk of overcharge caused by regenerative braking raising an instant state of charge of the battery to exceed its maximum storage capacity by determining the adjusted storage capacity to provide a buffer charge capacity.

12. The method of claim 11, wherein the information comprises barometric pressure, the method further comprising:
(e) interpreting the barometric pressure by the analytic component to calculate the determined elevation.

13. The method of claim 11, further comprising:
(f) reducing the adjusted storage capacity to correspond with an increase in the determined elevation.

14. The method of claim 11, wherein the information further comprises a load weight and the sensor comprises a load sensor to detect the load weight, the method further comprising:
(g) reducing the adjusted storage capacity to correspond with the load weight being increased.

15. The method of claim 11, wherein the information comprises barometric pressure, load weight, the instant state of charge, battery capacity, travel distance since the battery was last charged, and an initial trip state of charge.
